(19) United States
(12) Patent Application Publication
(10) Pub. No.: US 2026/0287610 A1
(43) Pub. Date: Sep. 24, 2026

(54) MEMS ACCELEROMETER UTILIZING THIN FILM MECHANICAL RESONATORS AND INTEGRATED PHOTONICS

(71) Applicant: Honeywell International Inc., Charlotte, NC (US)

(72) Inventors: Chad Fertig, Roseville, MN (US); Luke Horstman, Saint Louis Park, MN (US); Matthew Wade Puckett, Phoenix, AZ (US)

(73) Assignee: Honeywell International Inc., Charlotte, NC (US)

(21) Appl. No.: 19/343,948

(22) Filed: Sep. 29, 2025

Related U.S. Application Data
(60) Provisional application No. 63/776,839, filed on Mar. 24, 2025.

(51) Int. Cl. G01P 15/093

(52) U.S. Cl. CPC G01P 15/093

(57) ABSTRACT

An inertial sensor system comprises a MEMS accelerometer, comprising a framed substrate having a bottom surface; a proof mass suspended in the framed substrate over the bottom surface, the proof mass having a first side and an opposing second side; a first trampoline resonator suspended in the framed substrate and spaced apart from the proof mass, the first trampoline resonator connected to the first side of the proof mass by a first tether; and a second trampoline resonator suspended in the framed substrate and spaced apart from the proof mass, the second trampoline resonator connected to the second side of the proof mass by a second tether. A photonic chip is operatively connected to the MEMS accelerometer and includes a PLC layer comprising a routing waveguide arrangement; a first photonic grating in optical communication with the waveguide arrangement; and a second photonic grating in optical communication with the waveguide arrangement.

### CROSS REFERENCE TO RELATED APPLICATION

This application claims the benefit of and priority to U.S. Provisional Application No. 63/776,839, filed on Mar. 24, 2025, the disclosure of which is herein incorporated by reference.

### BACKGROUND

Mechanical frequency comb (MFC) based sensing is poised to become a transformative technology for inertial navigation on agile platforms operating with harsh dynamics. Advantages of MFC-based accelerometers are their potential for high, selectable sensitivity over an extended dynamic range. However, such accelerometers have not been demonstrated to date due to limitations in MFC performance and challenges with integration.

### SUMMARY

An inertial sensor system comprises a micro-electro-mechanical systems (MEMS) accelerometer, comprising a framed substrate having a bottom surface; a proof mass suspended in the framed substrate over the bottom surface, the proof mass having a first side and an opposing second side; a first trampoline resonator suspended in the framed substrate and spaced apart from the proof mass, the first trampoline resonator connected to the first side of the proof mass by a first tether; and a second trampoline resonator suspended in the framed substrate and spaced apart from the proof mass, the second trampoline resonator connected to the second side of the proof mass by a second tether. A photonic chip is operatively connected to the MEMS accelerometer, the photonic chip including a planar lightwave circuit (PLC) layer comprising a routing waveguide arrangement; a first photonic grating configured as an optical emitter/receiver, the first photonic grating in optical communication with the routing waveguide arrangement; and a second photonic grating configured as an optical emitter/receiver, the second photonic grating in optical communication with the routing waveguide arrangement.

### BRIEF DESCRIPTION OF THE DRAWINGS

Features of the present invention will become apparent to those skilled in the art from the following description with reference to the drawings. Understanding that the drawings depict only typical embodiments and are not therefore to be considered limiting in scope, the invention will be described with additional specificity and detail through the use of the accompanying drawings, in which:

FIG. 1 is a top view of a micro-electro-mechanical systems (MEMS) vibrating beam accelerometer that employs thin film mechanical resonators, according to one embodiment;

FIG. 2 is an exploded perspective view of a MEMS vibrating beam accelerometer that employs thin film mechanical resonators and integrated photonics, according to one embodiment;

FIG. 3A is an exploded perspective view of a MEMS accelerometer sensor system, according to one implementation;

FIG. 3B is an enlarged perspective view of an exemplary photonic grating emitter utilized in the MEMS accelerometer sensor system of FIG. 3A;

FIG. 4 schematically illustrates a method of tuning an optical lattice offset parameter in a MEMS accelerometer sensor system, according to an example implementation; and

FIG. 5 is a flow diagram of an operational method for a MEMS vibrating beam accelerometer that employs thin film mechanical resonators, according to an example implementation.

### DETAILED DESCRIPTION

In the following detailed description, embodiments are described in sufficient detail to enable those skilled in the art to practice the invention. It is to be understood that other embodiments may be utilized without departing from the scope of the invention. The following detailed description is, therefore, not to be taken in a limiting sense.

A micro-electro-mechanical systems (MEMS) accelerometer utilizing thin film mechanical resonators and integrated photonics is described herein.

The MEMS accelerometer is a single proof mass, single-axis, differential read-out vibrating beam accelerometer, in which the traditional “tuning fork” sense anchors are replaced by a mechanical frequency comb (MFC) produced by at least one trampoline resonator. The MFC on the trampoline resonator is optically driven and read-out with a planar photonics circuit that utilizes integrated photonic waveguides to route, project, and collect optical signals in an integrated, ultra-compact footprint. In general, a planar lightwave circuit (PLC) layer routes laser light from a diode laser and fiber optic based source, to interact with the MEMS components without external lenses.

The present approach also provides a thermo-opto-mechanical trampoline overtone MEMS sensor system, which is a fully integrated optical and MEMS sensor system utilizing a laser driven and sensed MFC to achieve extended dynamic range accelerometry. Specifically, the MEMS accelerometer can have a 30× improvement in dynamic range for the same (single) proof mass mode as compared to traditional vibrating beam accelerometers operating on the “drive and track” closed loop electronic excitation of a vibrating beam. This allows for the production of robust, fieldable inertial sensors.

In present MEMS sensor system, the MFC can be extremely wide (e.g., more than 30 strong comb teeth) and can exhibit complete phase locking and ultra-stable frequency spacing among the comb teeth. In some embodiments, the comb utilizes a high-Q silicon nitride MEMS trampoline resonator, with comb oscillations being created and sustained optically using a few milliwatts of unmodulated laser light. In addition, the MFC requires no externally supplied periodic drive signal or electronic phase locked loops.

Further details of various embodiments are described hereafter and with reference to the drawings.

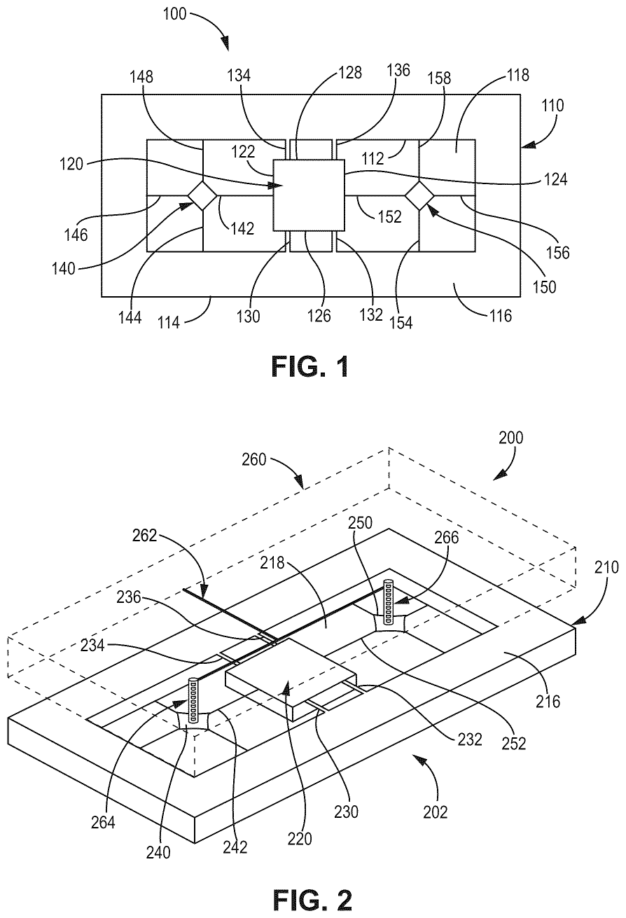

FIG. 1 illustrates a MEMS vibrating beam accelerometer 100, according to one embodiment. The accelerometer 100 includes a framed substrate 110 such as a silicon framed substrate, and a proof mass 120 such as silicon proof mass suspended in the framed substrate 110.

As shown, the framed substrate 110 has an inner wall 112, an outer wall 114, and a top frame surface 116 between the inner wall 112 and the outer wall 114. The framed substrate 110 also has a bottom surface 118 underlying the proof mass 120. The proof mass 120 has a first side 122, and an opposing second side 124. The proof mass 120 also has a third side 126, and an opposing fourth side 128. The proof mass 120 is connected to the framed substrate 110 by a first set of suspension structures 130, 132 connected between the third side 126 of the proof mass 120 and the inner wall 112, and a second set of suspension structures 134, 136 connected between the fourth side 128 of the proof mass 120 and the inner wall 112.

A first trampoline resonator 140, such as a thin film silicon nitride trampoline resonator, is suspended in the framed substrate 110 and spaced apart from the proof mass 120. The first trampoline resonator 140 is connected to the first side 122 of the proof mass 120 by a first tether 142. The first trampoline resonator 140 is also connected to the inner wall 112 of the framed substrate 110 by a set of additional tethers 144, 146, 148.

A second trampoline resonator 150, such as a thin film silicon nitride trampoline resonator, is also suspended in the framed substrate 110 and spaced apart from the proof mass 120. The second trampoline resonator 150 is connected to the second side 124 of the proof mass 120 by a second tether 152. The second trampoline resonator 150 is also connected to the inner wall 112 of the framed substrate 110 by a set of additional tethers 154, 156, 158.

The MEMS vibrating beam accelerometer 100 utilizes an MFC readout of the first and second trampoline resonators 140, 150 attached to the suspended proof mass 120. As described further hereafter, an all-optical drive and readout for the accelerometer can be implemented with photonic waveguides on a planar lightwave circuit layer.

FIG. 2 is a perspective view of a MEMS sensor unit 200 that employs a MEMS vibrating beam accelerometer 202 with thin film mechanical resonators and integrated photonics, according to one embodiment. The MEMS vibrating beam accelerometer 202 is similar to the MEMS vibrating beam accelerometer 100 described above (see FIG. 1). Accordingly, the MEMS vibrating beam accelerometer 202 includes a framed substrate 210 such as a silicon framed substrate, and a single proof mass 220 such as silicon proof mass suspended in the framed substrate 210.

As shown in FIG. 2, the framed substrate 210 has a top frame surface 216, which can have a silicon nitride layer formed thereon. The framed substrate 210 also has a bottom surface 218 underlying the proof mass 220. The proof mass 220 is connected to an inner wall of the framed substrate 210 by a first set of suspension structures 230, 232, and a second set of suspension structures 234, 236.

A first trampoline resonator 240, such as a thin film silicon nitride trampoline resonator, is suspended in the framed substrate 210 and connected to the proof mass 220 by a first tether 242. The first trampoline resonator 240 is also connected to the inner wall of the framed substrate 210 by additional tethers. A second trampoline resonator 250, such as a thin film silicon nitride trampoline resonator, is also suspended in the framed substrate 210 and is connected to the proof mass 220 by a second tether 252. The second trampoline resonator 250 is also connected to the inner wall of the framed substrate 210 by additional tethers.

The MEMS sensor unit 200 utilizes a photonic integrated circuit or chip that comprises a planar lightwave circuit (PLC) layer 260, which is operatively connected to the vibrating beam accelerometer 202 and positioned over the framed substrate 210. The PLC layer 260 provides a waveguide arrangement including a laser routing waveguide arrangement 262 that is optically coupled with a first photonic grating 264 configured as an optical emitter/receiver, and a second photonic grating 266 configured as an optical emitter/receiver.

The routing waveguide arrangement 262 is configured to direct laser light to the first photonic grating 264 and the second photonic grating 266. The first photonic grating 264 is configured to project the laser light in a collimated beam through the first trampoline resonator 240. The second photonic grating 266 is configured to project the laser light in a collimated beam through the second trampoline resonator 250. An optical lattice standing wave is created by a back reflection of the light from the bottom surface 218 of the framed substrate 210 under the first and second trampoline resonators 240, 250.

A fraction of the laser power incident on the first and second trampoline resonators 240, 250 is reflected, picking up frequency (Doppler) modulated sidebands that directly encode a mechanical frequency comb spectrum. The reflected light incident on the first and second photonic gratings 264, 266 is recoupled into the routing waveguide arrangement 262, to travel backwards and exit the PLC layer 260 such as through optical fibers, for optical detection and sensor processing as described further hereafter.

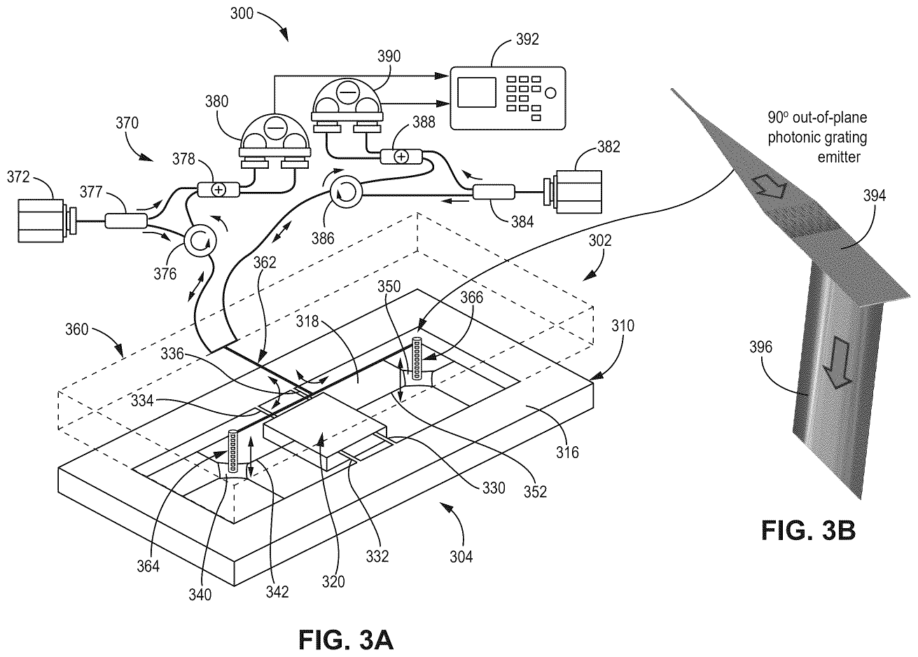

FIG. 3A illustrates an inertial sensor system 300, according to one implementation, which employs a MEMS sensor unit 302 similar to the MEMS sensor unit 200 described above (see FIG. 2). Accordingly, the MEMS sensor unit 302 includes a MEMS vibrating beam accelerometer 304 with a silicon framed substrate 310, and a silicon proof mass 320 suspended in the framed substrate 310. The framed substrate 310 has a top frame surface 316 with a silicon nitride (SiN) film thereon. The framed substrate 310 also has a bottom surface 318 underlying the proof mass 320. The proof mass 320 is connected to an inner wall of the framed substrate 310 by a first set of suspension structures 330, 332, and a second set of suspension structures 334, 336.

A first trampoline resonator 340 is suspended in the framed substrate 310 and connected to the proof mass 320 by a first tether 342. The first trampoline resonator 340 is also connected to the inner wall of the framed substrate 310 by additional tethers. A second trampoline resonator 350 is also suspended in the framed substrate 310 and is connected to the proof mass 320 by a second tether 352. The second trampoline resonator 350 is also connected to the inner wall of the framed substrate 310 by additional tethers.

The MEMS sensor unit 302 utilizes a photonic chip 360 that comprises a PLC layer operatively connected to the vibrating beam accelerometer 304 and positioned over the framed substrate 310. The PLC layer provides a waveguide arrangement including a laser routing waveguide arrangement 362 that is optically coupled with a first photonic grating 364 configured as an optical emitter/receiver, and a second photonic grating 366 configured as an optical emitter/receiver.

As shown in FIG. 3A, the inertial sensor system 300 also includes a laser drive and readout arrangement 370 that is in optical communication with the MEMS sensor unit 302. The laser drive and readout arrangement 370 includes a first laser source 372 in optical communication with the photonic chip 360 through a first optical chain that includes a first optical splitter 374 and a first optical circulator 376. A first optical combiner 378 is in optical communication with the first optical splitter 374 and the first optical circulator 376. A first balanced detection unit 380 is in optical communication with the first optical combiner 378.

The laser drive and readout arrangement 370 also includes a second laser source 382 in optical communication with the photonic chip 360 through a second optical chain that includes a second optical splitter 384 and a second optical circulator 386. A second optical combiner 388 is in optical communication with the second optical splitter 384 and the second optical circulator 386. A second balanced detection unit 390 is in optical communication with the second optical combiner 388. In addition, a readout device 392, such as a digital oscilloscope with at least one processor having a Fast Fourier Transform (FFT) function, is operatively connected to the first and second balanced detection units 380, 390.

In one embodiment, the first and second laser sources 372, 382 can be based on commercial off-the-shelf (COTS) fiber pigtailed diode lasers (e.g., λ=780 nm), which are fiber coupled into a silicon nitride waveguide at the edge of the PLC layer. In addition, the first optical combiner 378 and the first balanced detection unit 380 can be configured as a first interferometer, and the second optical combiner 388 and the second balanced detection unit 390 can be configured as a second interferometer.

During operation, a first light beam emitted by the first laser source 372 is sent to the first optical splitter 374, which splits the first light beam such that a first beam portion is directed to the first optical circulator 376 and a reference beam portion is directed to the first optical combiner 378. The first beam portion is directed by the first optical circulator 376 to the edge of the PLC layer and coupled into the routing waveguide arrangement 362. In addition, a second light beam emitted by the second laser source 382 is sent to the second optical splitter 384, which splits the second light beam such that a second beam portion is directed to the second optical circulator 386 and a reference beam portion is directed to the second optical combiner 388. The second beam portion is directed by the second optical circulator 386 to an edge of the PLC layer and coupled into the routing waveguide arrangement 362.

The routing waveguide arrangement 362 respectfully directs the beam portions to the first photonic grating 364 and the second photonic grating 366. The first photonic grating 364 projects one beam portion as a first collimated beam through the first trampoline resonator 340. The second photonic grating 366 projects the other beam portion as a second collimated beam through the second trampoline resonator 350. An optical lattice standing wave is created by a back reflection of the collimated beams from the bottom surface 318 of the framed substrate 310 under the first and second trampoline resonators 340, 350.

A fraction of the laser power incident on the first and second trampoline resonators 340, 350 is reflected, picking up frequency (Doppler) modulated sidebands that directly encode a mechanical frequency comb spectrum. The reflected light incident on the first and second photonic gratings 364, 366 is recoupled into the routing waveguide arrangement 362, to travel backwards and exit the PLC layer through respective optical fibers coupled to the first and second optical circulators 376, 386.

The reflected light from the first optical circulator 376 is combined with the reference beam portion in the first optical combiner 378 and then sent to a first port of the first balanced detection unit 380, and the reference beam portion in the first optical combiner 378 is also sent to a second port of the first balanced detection unit 380. The reflected light from the second optical circulator 386 is combined with the reference beam portion in the second optical combiner 388 and then sent to a first port of the second balanced detection unit 390, and the reference beam portion in the second optical combiner 388 is also sent to a second port of the second balanced detection unit 390. The output signals from the first and second balanced detection units 380, 390 are sent to the readout device 392 for signal processing and performing laser Doppler vibrometry (LDV), which is described in further detail hereafter.

FIG. 3B is an enlarged perspective view of a high efficiency photonic grating emitter/receiver 394, which can be employed as the photonic gratings 364, 366 in the inertial sensor system 300 of FIG. 3A. FIG. 3B depicts finite element analysis (FEA) modeling of the photonic grating emitter/receiver 394, which directs an input laser beam as a 90° out-of-plane collimated beam 396 toward a trampoline resonator. The photonic grating emitter/receiver 394 can be an approximate 10 μm sized diffractive waveguide grating, which projects about 50% of the laser power into the collimated beam 396.

Further details of various aspects of the present MEMS accelerometer sensor system are described hereafter.

### Overtone Mechanical Frequency Combs

The present MEMS accelerometer uses an overtone mechanical frequency comb (MFC), which can be implemented as a thermo-opto-mechanical overtone frequency comb using suspended trampoline resonators, such as high-Q silicon nitride trampoline resonators. The overtone MFC uses a simple comb generation and readout method (e.g., needing only a single, unmodulated laser beam of about 3 mW); has a large number (e.g., greater than 30) of high power, high signal-to-noise ratio (SNR), phase coherent comb teeth; and has long-term stability (e.g., better than 7E-10 fractional frequency stability over several hours) and equal spacing between overtone frequencies.

Further details regarding overtone MFCs can be found in de Jong et al., Mechanical Overtone Frequency Combs, Nature Communications 14, no. 1 (Mar. 16, 2023): 1458, the disclosure of which is incorporated by reference herein.

### Integrated Photonics Laser Delivery

The present MEMS accelerometer is implemented with an integrated planar lightwave circuit (PLC) platform, which can be based on low-loss silicon nitride, for the generation of tailored free space lasers beams inside the MEMS accelerometer. The PLC platform provides for shrinking the footprint of the optical chain for the laser drive and readout of the two trampoline resonators (overtone MFCs), delivering the optical lattice laser and returning the reflected light for a laser Doppler vibrometry (LDV) readout without using bulky microscope objectives.

A laser source can be based on a commercial off-the-shelf (COTS) fiber pigtailed laser (e.g., at λ=780 nm), fiber coupled into a silicon nitride waveguide at the edge of the PLC. The waveguide carries the laser light to an approximate 10 μm sized diffractive waveguide grating, which projects about 50% of the laser power into a collimated beam straight down through one trampoline resonator. The optical lattice standing wave is created by the back reflection of the light from a silicon surface of the substrate under the released trampoline resonator. It has been shown that a 30% reflectivity from a silicon surface is sufficient for comb formation.

In some implementations, a reflector layer can be formed in the silicon surface, which is revealed during a release etch, to present a reflectivity as high as 90%, to further boost the strength of the overtone MFC. In addition, the size or shape of a laser spot is not limiting, so long as the total beam power is above a threshold value, as differently shaped beam spots have not been observed to adversely impact the formation of a good overtone MFC.

### In-Situ Tuning of Optical Lattice Offset Parameter

In some embodiments, a method of in-situ tuning of the optical lattice “offset” parameter x₀, which is the distance of the film from the nearest anti-node of the optical standing wave, is needed to compensate for process variations in the release etch when forming a reflector layer. This can be achieved by temperature tuning of a diode laser emission wavelength. Specifically, COTS fiber pigtailed laser diode modules come with integrated thermoelectric elements for precisely tuning and stabilizing the laser diode temperature to far tighter than +/−1° C. This in turn translates into control of the laser wavelength to far tighter than +/−0.3 nm.

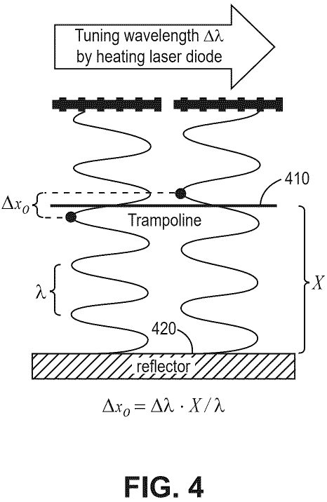

FIG. 4 schematically illustrates a method of tuning the optical lattice offset parameter, according to an example implementation. As illustrated, the optical boundary conditions in a retro-reflected optical lattice enforce a node at a reflector, and this implies that any change in the wavelength of the laser, such as by heating of the laser diode, causes a magnified translation of the lattice across the trampoline film. The offset translation is given by Δx₀=Δλ·X/λ. Thus, for a trampoline resonator 410 located X=200 μm from a reflector layer 420, the offset parameter x₀ can be tuned at a rate of 76 nm/° C., which is needed for optimizing the strength of the overtone MFC, and for selectively exciting overtones of even or odd parity as desired. Finally, such changes to the optical lattice do not change the frequency of the comb teeth, as these are determined solely by intrinsic properties of the suspended trampoline film.

### Integrated Laser Doppler Vibrometry Readout

The present MEMS accelerometer sensor system can have an integrated LDV readout of the trampoline resonator comb spectra. A small fraction (e.g., about 10%) of the laser power incident on the trampoline is reflected, picking up frequency (Doppler) modulated sidebands that directly encode the mechanical frequency comb spectrum. The reflected light incident on the grating emitter/receiver is recoupled into the original feed waveguide, to travel backwards and exit the PLC through the (same) optical fiber. This light is split off by a COTS optical circulator and directed into one port of an in-fiber homodyne interferometer comprised of a COTS 2×2 fiber beam combiner and two photodiodes. The other port of the interferometer is fed with a portion of the laser diode output as a reference oscillator. In the usual manner of LDV, the output of the interferometer is an AC electrical signal with a spectrum that replicates the mechanical frequency comb spectrum of the overtone MFC. Note that the interferometer rejects laser diode frequency noise from degrading the overtone MFC signals.

An advantage of the LDV readout is that since it is sensitive to the velocity and not the position of the vibrating trampoline membrane, the LDV readout does not exhibit the folding ambiguity of a fringe-counting interferometer, or the signal saturation effect of a capacitive gap sensor. Another advantage is that since the frequency signature of every comb tooth is present in the signal, the processing electronics can select “on the fly” which comb tooth provides the most useful scale factor for inertial sensing, making this a uniquely flexible readout scheme as compared to those that employ tracking oscillators electronically locked to one pre-selected comb tooth. A micro-packaged version of the electronics for the LDV readout can be miniaturized to a circuit board level or even to an application-specific integrated circuit (ASIC) level.

### Selectable Scale Factor

As described previously, in the present vibrating beam accelerometer architecture, two traditional tuning-fork sense anchors are replaced by the two trampoline resonators for which tethers are connected directly to the proof mass. Inertial forces on the proof mass cause (oppositely signed) changes to the stress in each trampoline resonator, tuning the frequency spacing of each overtone MFC. The tuning rate of a given comb tooth scales exactly as its tooth index n, implying that a 30 tooth comb presents 30 different selectable acceleration sensing scale factors spanning a dynamic range of over 14 dB. Moreover, it has been found that the SNR and linewidth of every strong comb tooth is approximately equal, so changing the dynamic range of the accelerometer by picking a high index tooth does not degrade acceleration sensitivity. In this way, the present MEMS accelerometer sensor system utilizes mechanical frequency combs for inertial sensing with high SNR, over a wide dynamic range, using a single proof mass.

### Example Operational Method

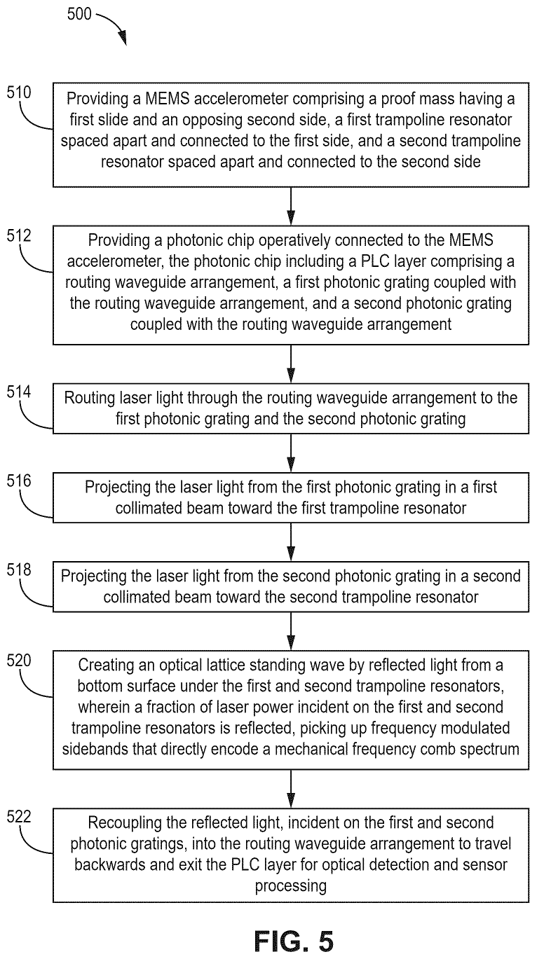

FIG. 5 is a flow diagram of an operational method 500 for a MEMS vibrating beam accelerometer that employs thin film mechanical resonators, according to an example implementation. The method 500 comprises providing a MEMS accelerometer comprising a proof mass having a first side and an opposing second side, a first trampoline resonator spaced apart and connected to the first side, and a second trampoline resonator spaced apart and connected to the second side (block 510). The method 500 also includes providing a photonic chip operatively connected to the MEMS accelerometer, the photonic chip including a PLC layer comprising a routing waveguide arrangement, a first photonic grating coupled with the routing waveguide arrangement, and a second photonic grating coupled with the routing waveguide arrangement (block 512).

During operation, the method 500 comprises routing laser light through the routing waveguide arrangement to the first photonic grating and the second photonic grating (block 514); projecting the laser light from the first photonic grating in a first collimated beam toward the first trampoline resonator (block 516); and projecting the laser light from the second photonic grating in a second collimated beam toward the second trampoline resonator (block 518). This creates an optical lattice standing wave by reflected light from a bottom surface under the first and second trampoline resonators, wherein a fraction of laser power incident on the first and second trampoline resonators is reflected, picking up frequency modulated sidebands that directly encode a mechanical frequency comb spectrum (block 520). The method 500 then recouples the reflected light, incident on the first and second photonic gratings, into the routing waveguide arrangement to travel backwards and exit the PLC layer for optical detection and sensor processing (block 522).

The processing units and/or other computational devices used in the systems and methods described herein may be implemented using software, firmware, hardware, or appropriate combinations thereof. The processing unit and/or other computational devices may be supplemented by, or incorporated in, specially-designed ASICs or field programmable gate arrays (FPGAs). In some implementations, the processing unit and/or other computational devices may communicate through an additional transceiver with other computing devices outside of the navigation system, such as those associated with a management system or computing devices associated with other subsystems controlled by the management system. The processing unit and/or other computational devices can also include or function with software programs, firmware, or other computer readable instructions for carrying out various process tasks, calculations, and control functions used in the methods and systems described herein.

The methods described herein may be implemented by computer executable instructions, such as program modules or components, which are executed by at least one processor or processing unit. Generally, program modules include routines, programs, objects, data components, data structures, algorithms, and the like, which perform particular tasks or implement particular abstract data types.

Instructions for carrying out the various process tasks, calculations, and generation of other data used in the operation of the methods described herein can be implemented in software, firmware, or other computer readable instructions. These instructions are typically stored on appropriate computer program products that include computer readable media used for storage of computer readable instructions or data structures. Such a computer readable medium may be available media that can be accessed by a general purpose or special purpose computer or processor, or any programmable logic device.

Suitable computer readable storage media may include, for example, non-volatile memory devices including semi-conductor memory devices such as Random Access Memory (RAM), Read Only Memory (ROM), Electrically Erasable Programmable ROM (EEPROM), or flash memory devices; magnetic disks such as internal hard disks or removable disks; optical storage devices such as compact discs (CDs), digital versatile discs (DVDs), Blu-ray discs; or any other media that can be used to carry or store desired program code in the form of computer executable instructions or data structures.

### Example Embodiments

Example 1 includes an inertial sensor system comprising: a micro-electro-mechanical systems (MEMS) accelerometer comprising: a framed substrate having a bottom surface; a proof mass suspended in the framed substrate over the bottom surface, the proof mass having a first side and an opposing second side; a first trampoline resonator suspended in the framed substrate and spaced apart from the proof mass, the first trampoline resonator connected to the first side of the proof mass by a first tether; and a second trampoline resonator suspended in the framed substrate and spaced apart from the proof mass, the second trampoline resonator connected to the second side of the proof mass by a second tether; and a photonic chip operatively connected to the MEMS accelerometer, the photonic chip including a planar lightwave circuit (PLC) layer comprising: a routing waveguide arrangement; a first photonic grating configured as an optical emitter/receiver, the first photonic grating in optical communication with the routing waveguide arrangement; and a second photonic grating configured as an optical emitter/receiver, the second photonic grating in optical communication with the routing waveguide arrangement.
Example 2 includes the inertial sensor system of Example 1, wherein: the PLC layer is configured to route laser light through the routing waveguide arrangement to the first photonic grating and the second photonic grating; and the first photonic grating is configured to project the laser light in a first collimated beam toward the first trampoline resonator, and the second photonic grating is configured to project the laser light in a second collimated beam toward the second trampoline resonator.
Example 3 includes the inertial sensor system of Example 2, wherein: an optical lattice standing wave is created by reflected light from the bottom surface of the framed substrate under the first and second trampoline resonators, and a fraction of laser power incident on the first and second trampoline resonators is reflected, picking up frequency modulated sidebands that directly encode a mechanical frequency comb spectrum.
Example 4 includes the inertial sensor system of Example 3, wherein the reflected light, incident on the first and second photonic gratings, is recoupled into the routing waveguide arrangement, to travel backwards and exit the PLC layer for optical detection and sensor processing.
Example 5 includes the inertial sensor system of any of Examples 1-4, further comprising: a laser drive and readout arrangement in optical communication with the PLC layer of the photonic chip.
Example 6 includes the inertial sensor system of Example 5, wherein the laser drive and readout arrangement comprises: a first laser source in optical communication with the photonic chip through a first optical chain that includes a first optical splitter, a first optical circulator, and a first optical combiner in optical communication with the first optical splitter and the first optical circulator; and a first balanced detection unit in optical communication with the first optical combiner.
Example 7 includes the inertial sensor system of Example 6, wherein the laser drive and readout arrangement further comprises: a second laser source in optical communication with the photonic chip through a second optical chain that includes a second optical splitter, a second optical circulator, and a second optical combiner in optical communication with the second optical splitter and the second optical circulator; and a second balanced detection unit in optical communication with the second optical combiner.
Example 8 includes the inertial sensor system of Example 7, further comprising a readout device operatively connected to the first and second balanced detection units, the readout device operative to perform laser Doppler vibrometry (LDV).
Example 9 includes the inertial sensor system of any of Examples 1-8, wherein the first and second trampoline resonators comprise thin film silicon nitride trampoline resonators.
Example 10 includes the inertial sensor system of any of Examples 1-9, wherein the first and second trampoline resonators are configured to generate thermo-opto-mechanical overtone frequency combs.
Example 11 includes a method comprising: providing a micro-electro-mechanical systems (MEMS) accelerometer comprising a proof mass having a first side and an opposing second side, a first trampoline resonator spaced apart and connected to the first side, and a second trampoline resonator spaced apart and connected to the second side; providing a photonic chip operatively connected to the MEMS accelerometer, the photonic chip including a planar lightwave circuit (PLC) layer comprising a routing waveguide arrangement, a first photonic grating coupled with the routing waveguide arrangement, and a second photonic grating coupled with the routing waveguide arrangement; routing laser light through the routing waveguide arrangement to the first photonic grating and the second photonic grating; projecting the laser light from the first photonic grating in a first collimated beam toward the first trampoline resonator; projecting the laser light from the second photonic grating in a second collimated beam toward the second trampoline resonator; creating an optical lattice standing wave by reflected light from a bottom surface under the first and second trampoline resonators, wherein a fraction of laser power incident on the first and second trampoline resonators is reflected, picking up frequency modulated sidebands that directly encode a mechanical frequency comb spectrum; and recoupling the reflected light, incident on the first and second photonic gratings, into the routing waveguide arrangement to travel backwards and exit the PLC layer for optical detection and sensor processing.
Example 12 includes the method of Example 11, wherein the MEMS accelerometer and photonic chip are implemented in an inertial sensor system.
Example 13 includes the method of Example 12, wherein the inertial sensor system includes a laser drive and readout arrangement in optical communication with the PLC layer of the photonic chip.
Example 14 includes the method of Example 13, wherein the laser drive and readout arrangement comprises: a first laser source in optical communication with the photonic chip through a first optical chain that includes a first optical splitter, a first optical circulator, and a first optical combiner in optical communication with the first optical splitter and the first optical circulator; and a first balanced detection unit in optical communication with the first optical combiner.
Example 15 includes the method of Example 14, wherein the laser drive and readout arrangement further comprises: a second laser source in optical communication with the photonic chip through a second optical chain that includes a second optical splitter, a second optical circulator, and a second optical combiner in optical communication with the second optical splitter and the second optical circulator; and a second balanced detection unit in optical communication with the second optical combiner.
Example 16 includes the method of Example 15, further comprising a readout device operatively connected to the first and second balanced detection units, wherein the readout device performs laser Doppler vibrometry (LDV).
Example 17 includes the method of Example 16, wherein the laser light comprises: a first light beam emitted by the first laser source that is sent to the first optical splitter, which splits the first light beam such that a first beam portion is directed to the first optical circulator and a reference beam portion is directed to the first optical combiner, wherein the first beam portion is directed by the first optical circulator to the PLC layer and coupled into the routing waveguide arrangement; and a second light beam emitted by the second laser source that is sent to the second optical splitter, which splits the second light beam such that a second beam portion is directed to the second optical circulator and a reference beam portion is directed to the second optical combiner, wherein the second beam portion is directed by the second optical circulator to the PLC layer and coupled into the routing waveguide arrangement.
Example 18 includes the method of Example 17, wherein: the routing waveguide arrangement respectfully directs the first beam portion to the first photonic grating and the second beam portion to the second photonic grating; the first photonic grating projects the first beam portion as the first collimated beam toward the first trampoline resonator; and the second photonic grating projects the second beam portion as the second collimated beam toward the second trampoline resonator.
Example 19 includes the method of Example 18, wherein: the reflected light exits the PLC layer through respective optical fibers coupled to the first and second optical circulators; the reflected light from the first optical circulator is combined with the reference beam portion in the first optical combiner and then sent to a first port of the first balanced detection unit, and the reference beam portion in the first optical combiner is also sent to a second port of the first balanced detection unit; the reflected light from the second optical circulator is combined with the reference beam portion in the second optical combiner and then sent to a first port of the second balanced detection unit, and the reference beam portion in the second optical combiner is also sent to a second port of the second balanced detection unit; and output signals from the first and second balanced detection units are sent to the readout device for signal processing and for performing the LDV.
Example 20 includes the method of any of Examples 11-19, wherein the first and second trampoline resonators generate thermo-opto-mechanical overtone frequency combs.

The present invention may be embodied in other specific forms without departing from its essential characteristics. The described embodiments are to be considered in all respects only as illustrative and not restrictive. The scope of the invention is therefore indicated by the appended claims rather than by the foregoing description. All changes that come within the meaning and range of equivalency of the claims are to be embraced within their scope.

What is claimed is:

1. An inertial sensor system comprising:
a micro-electro-mechanical systems (MEMS) accelerometer comprising:
a framed substrate having a bottom surface;
a proof mass suspended in the framed substrate over the bottom surface, the proof mass having a first side and an opposing second side;
a first trampoline resonator suspended in the framed substrate and spaced apart from the proof mass, the first trampoline resonator connected to the first side of the proof mass by a first tether; and
a second trampoline resonator suspended in the framed substrate and spaced apart from the proof mass, the second trampoline resonator connected to the second side of the proof mass by a second tether; and
a photonic chip operatively connected to the MEMS accelerometer, the photonic chip including a planar lightwave circuit (PLC) layer comprising:
a routing waveguide arrangement;
a first photonic grating configured as an optical emitter/receiver, the first photonic grating in optical communication with the routing waveguide arrangement; and
a second photonic grating configured as an optical emitter/receiver, the second photonic grating in optical communication with the routing waveguide arrangement.

2. The inertial sensor system of claim 1, wherein:
the PLC layer is configured to route laser light through the routing waveguide arrangement to the first photonic grating and the second photonic grating; and
the first photonic grating is configured to project the laser light in a first collimated beam toward the first trampoline resonator, and the second photonic grating is configured to project the laser light in a second collimated beam toward the second trampoline resonator.

3. The inertial sensor system of claim 2, wherein:
an optical lattice standing wave is created by reflected light from the bottom surface of the framed substrate under the first and second trampoline resonators, and a fraction of laser power incident on the first and second trampoline resonators is reflected, picking up frequency modulated sidebands that directly encode a mechanical frequency comb spectrum.

4. The inertial sensor system of claim 3, wherein the reflected light, incident on the first and second photonic gratings, is recoupled into the routing waveguide arrangement, to travel backwards and exit the PLC layer for optical detection and sensor processing.

5. The inertial sensor system of claim 1, further comprising:
a laser drive and readout arrangement in optical communication with the PLC layer of the photonic chip.

6. The inertial sensor system of claim 5, wherein the laser drive and readout arrangement comprises:
a first laser source in optical communication with the photonic chip through a first optical chain that includes a first optical splitter, a first optical circulator, and a first optical combiner in optical communication with the first optical splitter and the first optical circulator; and
a first balanced detection unit in optical communication with the first optical combiner.

7. The inertial sensor system of claim 6, wherein the laser drive and readout arrangement further comprises:
a second laser source in optical communication with the photonic chip through a second optical chain that includes a second optical splitter, a second optical circulator, and a second optical combiner in optical communication with the second optical splitter and the second optical circulator; and
a second balanced detection unit in optical communication with the second optical combiner.

8. The inertial sensor system of claim 7, further comprising a readout device operatively connected to the first and second balanced detection units, the readout device operative to perform laser Doppler vibrometry (LDV).

9. The inertial sensor system of claim 1, wherein the first and second trampoline resonators comprise thin film silicon nitride trampoline resonators.

10. The inertial sensor system of claim 1, wherein the first and second trampoline resonators are configured to generate thermo-opto-mechanical overtone frequency combs.

11. A method comprising:
providing a micro-electro-mechanical systems (MEMS) accelerometer comprising a proof mass having a first side and an opposing second side, a first trampoline resonator spaced apart and connected to the first side, and a second trampoline resonator spaced apart and connected to the second side;
providing a photonic chip operatively connected to the MEMS accelerometer, the photonic chip including a planar lightwave circuit (PLC) layer comprising a routing waveguide arrangement, a first photonic grating coupled with the routing waveguide arrangement, and a second photonic grating coupled with the routing waveguide arrangement;
routing laser light through the routing waveguide arrangement to the first photonic grating and the second photonic grating;
projecting the laser light from the first photonic grating in a first collimated beam toward the first trampoline resonator;
projecting the laser light from the second photonic grating in a second collimated beam toward the second trampoline resonator;
creating an optical lattice standing wave by reflected light from a bottom surface under the first and second trampoline resonators, wherein a fraction of laser power incident on the first and second trampoline resonators is reflected, picking up frequency modulated sidebands that directly encode a mechanical frequency comb spectrum; and
recoupling the reflected light, incident on the first and second photonic gratings, into the routing waveguide arrangement to travel backwards and exit the PLC layer for optical detection and sensor processing.

12. The method of claim 11, wherein the MEMS accelerometer and photonic chip are implemented in an inertial sensor system.

13. The method of claim 12, wherein the inertial sensor system includes a laser drive and readout arrangement in optical communication with the PLC layer of the photonic chip.

14. The method of claim 13, wherein the laser drive and readout arrangement comprises:
a first laser source in optical communication with the photonic chip through a first optical chain that includes a first optical splitter, a first optical circulator, and a first optical combiner in optical communication with the first optical splitter and the first optical circulator; and
a first balanced detection unit in optical communication with the first optical combiner.

15. The method of claim 14, wherein the laser drive and readout arrangement further comprises:
a second laser source in optical communication with the photonic chip through a second optical chain that includes a second optical splitter, a second optical circulator, and a second optical combiner in optical communication with the second optical splitter and the second optical circulator; and
a second balanced detection unit in optical communication with the second optical combiner.

16. The method of claim 15, further comprising a readout device operatively connected to the first and second balanced detection units, wherein the readout device performs laser Doppler vibrometry (LDV).

17. The method of claim 16, wherein the laser light comprises:
a first light beam emitted by the first laser source that is sent to the first optical splitter, which splits the first light beam such that a first beam portion is directed to the first optical circulator and a reference beam portion is directed to the first optical combiner, wherein the first beam portion is directed by the first optical circulator to the PLC layer and coupled into the routing waveguide arrangement; and
a second light beam emitted by the second laser source that is sent to the second optical splitter, which splits the second light beam such that a second beam portion is directed to the second optical circulator and a reference beam portion is directed to the second optical combiner, wherein the second beam portion is directed by the second optical circulator to the PLC layer and coupled into the routing waveguide arrangement.

18. The method of claim 17, wherein:
the routing waveguide arrangement respectfully directs the first beam portion to the first photonic grating and the second beam portion to the second photonic grating;
the first photonic grating projects the first beam portion as the first collimated beam toward the first trampoline resonator; and
the second photonic grating projects the second beam portion as the second collimated beam toward the second trampoline resonator.

19. The method of claim 18, wherein:
the reflected light exits the PLC layer through respective optical fibers coupled to the first and second optical circulators;
the reflected light from the first optical circulator is combined with the reference beam portion in the first optical combiner and then sent to a first port of the first balanced detection unit, and the reference beam portion in the first optical combiner is also sent to a second port of the first balanced detection unit;
the reflected light from the second optical circulator is combined with the reference beam portion in the second optical combiner and then sent to a first port of the second balanced detection unit, and the reference beam portion in the second optical combiner is also sent to a second port of the second balanced detection unit; and
output signals from the first and second balanced detection units are sent to the readout device for signal processing and for performing the LDV.

20. The method of claim 11, wherein the first and second trampoline resonators generate thermo-opto-mechanical overtone frequency combs.
